(19) United States
(12) Patent Application Publication
(10) Pub. No.: US 2025/0345863 A1
(43) Pub. Date: Nov. 13, 2025

(54) DRILLING INSERT

(71) Applicant: MILWAUKEE ELECTRIC TOOL CORPORATION, Brookfield, WI (US)

(72) Inventors: Travis J. DuMez, Port Washington, WI (US); Brian R. Simpson, Milwaukee, WI (US); Brent M. Hiser, Lisbon, WI (US); Jacob J. Konieczka, Wauwatosa, WI (US)

(21) Appl. No.: 19/194,611

(22) Filed: Apr. 30, 2025

Related U.S. Application Data
(60) Provisional application No. 63/643,697, filed on May 7, 2024.

(51) Int. Cl. B23B 51/00

(52) U.S. Cl. CPC B23B 51/0006; B23B 2251/241

(57) ABSTRACT

A drilling insert includes a body having a length measured between a first end and a second end. The body includes a cutting head positioned at the first end of the body. The cutting head has a first maximum outer diameter. The body also includes a shank positioned at the second end of the body and configured to be coupled to a tool. The shank has a second maximum outer diameter that is less than the first maximum outer diameter. The body further includes a shaft extending between the shank and the cutting head. The shaft has a third maximum outer diameter that is less than the first maximum outer diameter. The shaft extends a majority of the length of the body. The drilling insert includes a cutting insert coupled to the cutting head and spanning over at least 50% of the first maximum outer diameter of the cutting head.

### CROSS-REFERENCE TO RELATED APPLICATIONS

This application claims priority to U.S. Provisional Application No. 63/643,697, filed May 7, 2024, the entire contents of which are incorporated by reference herein.

### FIELD

The present invention relates to tool bits such as drilling inserts and, more particularly, to tool bits configured for use with power tools.

### SUMMARY

In some aspects, the techniques described herein relate to a drilling insert including: a body having a first end, a second end opposite the first end, and a length measured between the first end and the second end, the body including a cutting head positioned at the first end of the body, the cutting head having a first maximum outer diameter, a shank positioned at the second end of the body and configured to be coupled to a tool, the shank having a second maximum outer diameter that is less than the first maximum outer diameter, and a shaft extending between the shank and the cutting head, the shaft having a third maximum outer diameter that is less than the first maximum outer diameter, the shaft extending a majority of the length of the body; and a cutting insert coupled to the cutting head and spanning over at least 50% of the first maximum outer diameter of the cutting head.

In some aspects, the techniques described herein relate to a drilling insert, wherein the cutting head defines a pocket that receives the cutting insert.

In some aspects, the techniques described herein relate to a drilling insert, wherein the cutting insert is generally cross-shaped.

In some aspects, the techniques described herein relate to a drilling insert, wherein the cutting insert is a linear plate.

In some aspects, the techniques described herein relate to a drilling insert, wherein the cutting insert is a first cutting insert, and the drilling insert further including a second cutting insert and a third cutting insert coupled to the cutting head on opposite sides of the first cutting insert.

In some aspects, the techniques described herein relate to a drilling insert, wherein a ratio of the third maximum outer diameter of the shaft to the second maximum outer diameter of the shank is between 0.5 and 2.

In some aspects, the techniques described herein relate to a drilling insert, wherein the third maximum outer diameter of the shaft is approximately equal to the second maximum outer diameter of the shank such that the ratio is approximately 1.

In some aspects, the techniques described herein relate to a drilling insert, wherein a ratio of the third maximum outer diameter of the shaft to the first maximum outer diameter of the cutting head is less than or equal to 0.7.

In some aspects, the techniques described herein relate to a drilling insert, wherein the ratio of the third maximum outer diameter of the shaft to the first maximum outer diameter of the cutting head is less than or equal to 0.5.

In some aspects, the techniques described herein relate to a drilling insert, wherein the body also includes a collar positioned between the shank and the shaft.

In some aspects, the techniques described herein relate to a drilling insert, wherein the shaft extends at least 75% of the length of the body.

In some aspects, the techniques described herein relate to a drilling insert, wherein the cutting head has a first cross-sectional area, the shank has a second cross-sectional area, the shaft has a third cross-sectional area, and wherein a ratio of the third cross-sectional area to the second cross-sectional area is between 0.5 and 3.

In some aspects, the techniques described herein relate to a drilling insert, wherein the shank includes a plurality of slots and a plurality of detent recesses that are configured to receive coupling features of a tool, wherein the ratio of the third cross-sectional area to the second cross-sectional area is greater than 0.5 when the second cross-sectional area is taken at a location of the shank including the plurality of slots and the plurality of detent recesses, and wherein the ratio of the third cross-sectional area to the second cross-sectional area is less than 3 when the second cross-sectional area is taken at a location of the shank spaced from the plurality of slots and the plurality of detent recesses.

In some aspects, the techniques described herein relate to a drilling insert, wherein the cutting head continuously increases in diameter from the third maximum outer diameter to the first maximum outer diameter.

In some aspects, the techniques described herein relate to a drilling insert, wherein the cutting insert defines an outer dimension that is greater than the first maximum outer diameter of the cutting head.

In some aspects, the techniques described herein relate to a drilling insert, wherein a bottom surface of the cutting insert is welded to an end surface of the body at the first end.

In some aspects, the techniques described herein relate to a drilling insert, wherein the drilling insert has an overall diameter that is at least two times the second maximum outer diameter.

In some aspects, the techniques described herein relate to a drilling insert, wherein the drilling insert has an overall diameter of at least 0.75 inches, and wherein the shank has an SDS plus configuration.

In some aspects, the techniques described herein relate to a drilling insert, wherein the drilling insert has an overall diameter of at least 1.25 inches, and wherein the shank has an SDS Max configuration.

In some aspects, the techniques described herein relate to a drilling insert including: a body having a first end, a second end opposite the first end, and a length measured between the first end and the second end, the body including a cutting head positioned at the first end of the body, the cutting head having a first cross-sectional area, a shank positioned at the second end of the body and configured to be coupled to a tool, the shank having a second cross-sectional area that is less than the first cross-sectional area, and a shaft extending between the shank and the cutting head, the shaft having a third cross-sectional area that is less than the first cross-sectional area, the shaft extending a majority of the length of the body; and a cutting insert coupled to the cutting head, wherein an end surface of the cutting head opposite the shaft is defined by a planar surface having a cross-shape.

In some aspects, the techniques described herein relate to a drilling insert, wherein the end surface of the cutting head defines a pocket that receives the cutting insert.

In some aspects, the techniques described herein relate to a drilling insert, wherein the end surface of the cutting head abuts a bottom surface of the cutting insert.

In some aspects, the techniques described herein relate to a drilling insert, wherein the cutting insert is generally cross-shaped.

In some aspects, the techniques described herein relate to a drilling insert, wherein the cutting insert is a linear plate.

In some aspects, the techniques described herein relate to a drilling insert, wherein the cutting insert is a first cutting insert, and the drilling insert further including a second cutting insert and a third cutting insert coupled to the cutting head on opposite sides of the first cutting insert.

In some aspects, the techniques described herein relate to a drilling insert, wherein a ratio of a maximum outer diameter of the shaft to a maximum outer diameter of the shank is between 0.5 and 2.

In some aspects, the techniques described herein relate to a drilling insert, wherein the maximum outer diameter of the shaft is approximately equal to the maximum outer diameter of the shank such that the ratio is approximately 1.

In some aspects, the techniques described herein relate to a drilling insert, wherein a ratio of a maximum outer diameter of the shaft to a maximum outer diameter of the cutting head is less than or equal to 0.7.

In some aspects, the techniques described herein relate to a drilling insert, wherein the ratio of a maximum outer diameter of the shaft to a maximum outer diameter of the cutting head is less than or equal to 0.5.

In some aspects, the techniques described herein relate to a drilling insert, wherein the body also includes a collar positioned between the shank and the shaft.

In some aspects, the techniques described herein relate to a drilling insert, wherein the shaft extends at least 75% of the length of the body.

In some aspects, the techniques described herein relate to a drilling insert, wherein a ratio of the third cross-sectional area to the second cross-sectional area is between 0.5 and 3.

In some aspects, the techniques described herein relate to a drilling insert, wherein the shank includes a plurality of slots and a plurality of detent recesses that are configured to receive coupling features of a tool, wherein the ratio of the third cross-sectional area to the second cross-sectional area is greater than 0.5 when the second cross-sectional area is taken at a location of the shank including the plurality of slots and the plurality of detent recesses, and wherein the ratio of the third cross-sectional area to the second cross-sectional area is less than 3 when the second cross-sectional area is taken at a location of the shank spaced from the plurality of slots and the plurality of detent recesses.

In some aspects, the techniques described herein relate to a drilling insert, wherein the cutting head continuously increases in diameter from a maximum outer diameter of the shaft to a maximum outer diameter of the cutting head.

In some aspects, the techniques described herein relate to a drilling insert, wherein the cutting insert defines an outer dimension that is greater than a maximum outer diameter of the cutting head.

In some aspects, the techniques described herein relate to a drilling insert, wherein a bottom surface of the cutting insert is welded to an end surface of the body at the first end.

In some aspects, the techniques described herein relate to a drilling insert, wherein the drilling insert has an overall diameter that is at least two times a maximum outer diameter of the shank.

In some aspects, the techniques described herein relate to a drilling insert, wherein the drilling insert has an overall diameter of at least 0.75 inches, and wherein the shank has an SDS plus configuration.

In some aspects, the techniques described herein relate to a drilling insert, wherein the drilling insert has an overall diameter of at least 1.25 inches, and wherein the shank has an SDS Max configuration.

In some aspects, the techniques described herein relate to a drilling insert including: a body having a first end, a second end opposite the first end, and a length measured between the first end and the second end, the body including a cutting head positioned at the first end of the body, the cutting head having a first maximum outer dimension, a shank positioned at the second end of the body and configured to be coupled to a tool, the shank having a second maximum outer dimension that is less than the first maximum outer dimension, and a shaft extending between the shank and the cutting head, the shaft having a third maximum outer dimension that is less than the first maximum outer dimension, the shaft extending a majority of the length of the body; and one or more cutting inserts coupled to the cutting head, the one or more cutting inserts including no more than four cutting inserts.

In some aspects, the techniques described herein relate to a drilling insert, wherein one of the one or more cutting inserts has a fourth outer dimension that is greater than the first maximum outer dimension.

In some aspects, the techniques described herein relate to a drilling insert, wherein one of the one or more cutting inserts has a fourth outer dimension that is at least 50% of the first maximum outer dimension.

In some aspects, the techniques described herein relate to a drilling insert, wherein the one or more cutting inserts includes no more than three cutting inserts.

In some aspects, the techniques described herein relate to a drilling insert, wherein the cutting head defines a pocket that receives the one or more cutting inserts.

In some aspects, the techniques described herein relate to a drilling insert, wherein one of the one or more the cuttings insert is generally cross-shaped.

In some aspects, the techniques described herein relate to a drilling insert, wherein one of the one or more the cutting inserts is a linear plate.

In some aspects, the techniques described herein relate to a drilling insert, wherein a ratio of the third maximum outer dimension of the shaft to the second maximum outer dimension of the shank is between 0.5 and 2.

In some aspects, the techniques described herein relate to a drilling insert, wherein the third maximum outer dimension of the shaft is approximately equal to the second dimension outer diameter of the shank such that the ratio is approximately 1.

In some aspects, the techniques described herein relate to a drilling insert, wherein a ratio of the third maximum outer dimension of the shaft to the first maximum outer dimension of the cutting head is less than or equal to 0.7.

In some aspects, the techniques described herein relate to a drilling insert, wherein the ratio of the third maximum outer dimension of the shaft to the first maximum outer dimension of the cutting head is less than or equal to 0.5.

In some aspects, the techniques described herein relate to a drilling insert, wherein the body also includes a collar positioned between the shank and the shaft.

In some aspects, the techniques described herein relate to a drilling insert, wherein the shaft extends at least 75% of the length of the body.

In some aspects, the techniques described herein relate to a drilling insert, wherein the cutting head has a first cross-sectional area, the shank has a second cross-sectional area, the shaft has a third cross-sectional area, and wherein a ratio of the third cross-sectional area to the second cross-sectional area is between 0.5 and 3.

In some aspects, the techniques described herein relate to a drilling insert, wherein the shank includes a plurality of slots and a plurality of detent recesses that are configured to receive coupling features of a tool, wherein the ratio of the third cross-sectional area to the second cross-sectional area is greater than 0.5 when the second cross-sectional area is taken at a location of the shank including the plurality of slots and the plurality of detent recesses, and wherein the ratio of the third cross-sectional area to the second cross-sectional area is less than 3 when the second cross-sectional area is taken at a location of the shank spaced from the plurality of slots and the plurality of detent recesses.

In some aspects, the techniques described herein relate to a drilling insert, wherein the cutting head continuously increases in diameter from the third maximum outer dimension to the first maximum outer dimension.

In some aspects, the techniques described herein relate to a drilling insert, wherein the cutting insert defines an outer dimension that is greater than the first maximum outer diameter of the cutting head.

In some aspects, the techniques described herein relate to a drilling insert, wherein a bottom surface of the cutting insert is welded to an end surface of the body at the first end.

In some aspects, the techniques described herein relate to a drilling insert, wherein the drilling insert has an overall diameter that is at least two times the second maximum outer dimension.

In some aspects, the techniques described herein relate to a drilling insert, wherein the drilling insert has an overall diameter of at least 0.75 inches, and wherein the shank has an SDS plus configuration.

In some aspects, the techniques described herein relate to a drilling insert, wherein the drilling insert has an overall diameter of at least 1.25 inches, and wherein the shank has an SDS Max configuration.

Other aspects of the disclosure will become apparent by consideration of the detailed description and accompanying drawings.

### BRIEF DESCRIPTION OF THE DRAWINGS

FIG. 1 is a perspective view of a drilling insert and a sleeve in accordance with an embodiment of the disclosure.

FIG. 2 is a cross-sectional view of the drilling insert and the sleeve taken along line 2-2 in FIG. 1.

FIG. 3 is a side view of the drilling insert of FIG. 1.

FIG. 4 is a perspective view of a head of the drilling insert of FIG. 1.

FIG. 5A is a front view of the drilling insert of FIG. 1.

FIG. 5B is a cross-sectional view of the drilling insert and the sleeve taken along line 5-5 in FIG. 1.

FIG. 6 is a perspective view of a cutting head of a drilling insert according to another embodiment of the disclosure.

FIG. 7 is a front view of the drilling insert of FIG. 6.

FIG. 8A is a side view of a drilling insert according to another embodiment of the disclosure.

FIG. 8B is a side view of a cutting head of the drilling insert of FIG. 8A.

FIG. 9 is a front view of the drilling insert of FIG. 8A.

### DETAILED DESCRIPTION

Before any embodiments of the invention are explained in detail, it is to be understood that the invention is not limited in its application to the details of construction and the arrangement of components set forth in the following description or illustrated in the following drawings. The invention is capable of other embodiments and of being practiced or of being carried out in various ways. As used herein, terms such as “approximately,” “substantially,” “about,” and the like are meant to encompass values within a rounding value and/or manufacturing tolerance of the value stated.

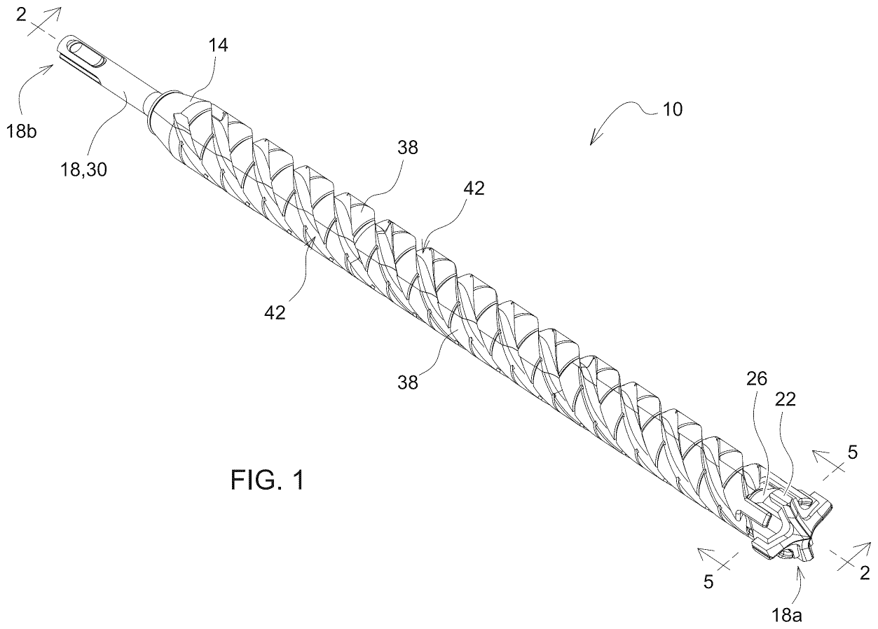

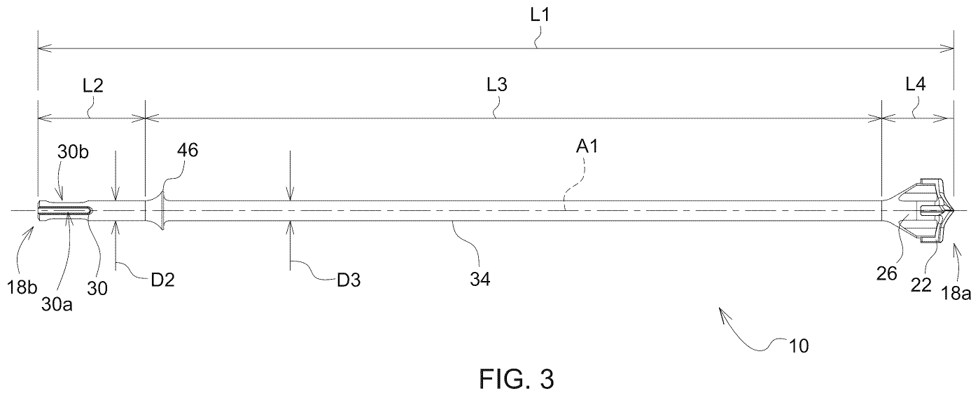

FIGS. 1-3 illustrate a drilling insert 10 and a sleeve 14 mounted on the drilling insert 10. The drilling insert 10 may also be referred to as a drill bit or a tunnel bit. Together, the drilling insert 10 and the sleeve 14 may be referred to as a drilling insert assembly, a drill bit assembly, or a tunnel bit assembly. The drilling insert 10 includes a body 18 and a cutting insert 22. The drilling insert 10 is configured for drilling relatively deep holes in a workpiece, such as concrete, concrete with rebar, brick, block, and other similar materials.

The body 18 has a first end 18a, a second end 18b opposite the first end 18a, and a length L1 measured between the first end 18a and the second end 18b. The length L1 may also be referred to as a total length or an overall length of the drilling insert 10. In some embodiments, the length L1 may range between about 12 inches and about 24 inches. In other embodiments, the drilling insert 10 may be longer or shorter. The body 18 is configured to rotate about a central longitudinal axis A1 that extends through the first end 18a and the second end 18b. The length L1 is measured parallel to the central longitudinal axis A1. The body 18 includes a cutting head 26 positioned at the first end 18a, a shank 30 positioned at the second end 18b, and a shaft 34 extending between the cutting head 26 and the shank 30. In the illustrated embodiment, the cutting head 26, the shank 30, and the shaft 34 are integrally formed as a single piece. In other embodiments, the cutting head 26, the shank 30, and/or the shaft 34 may be separate pieces that are secured (e.g., welded) together.

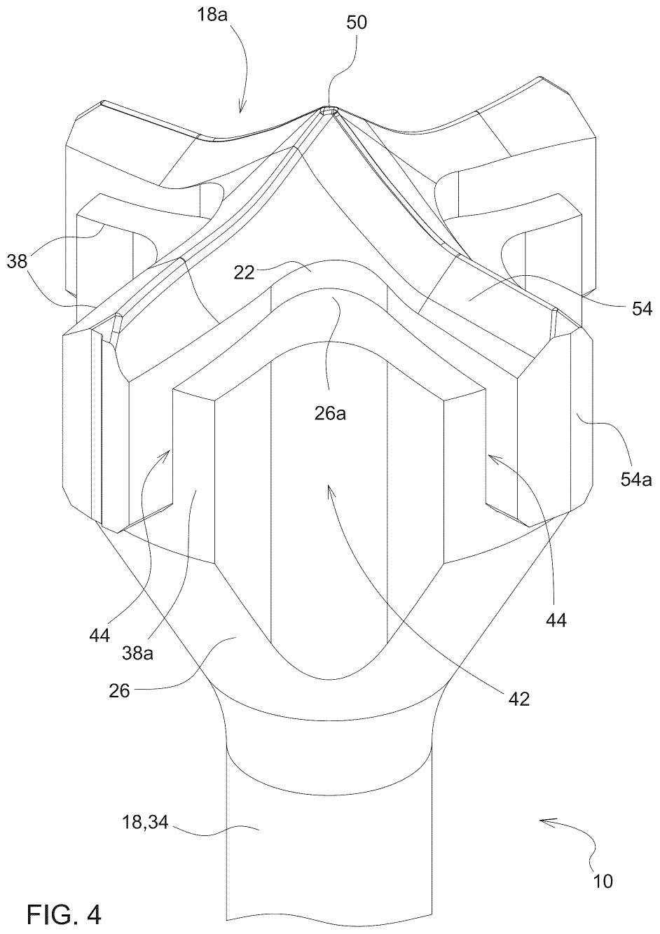

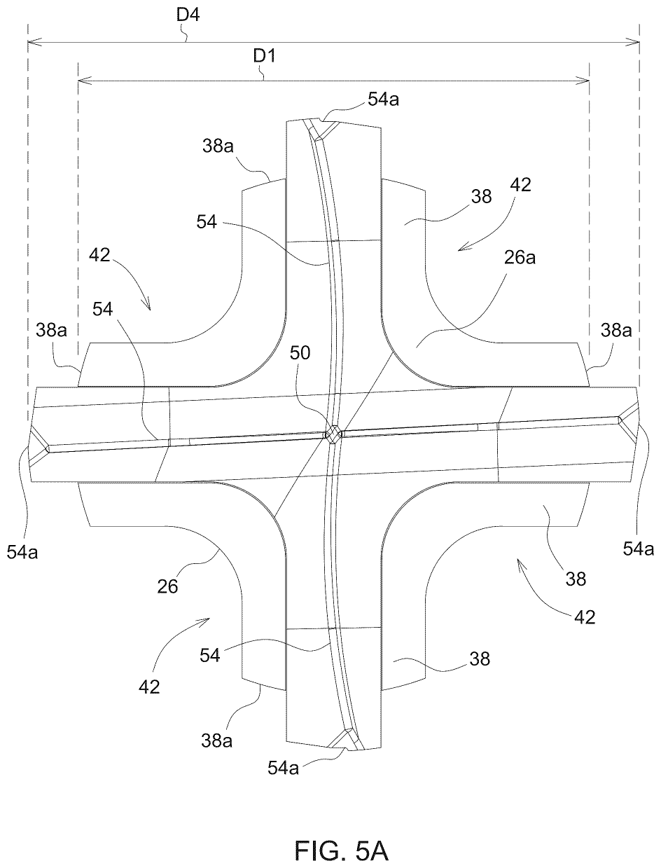

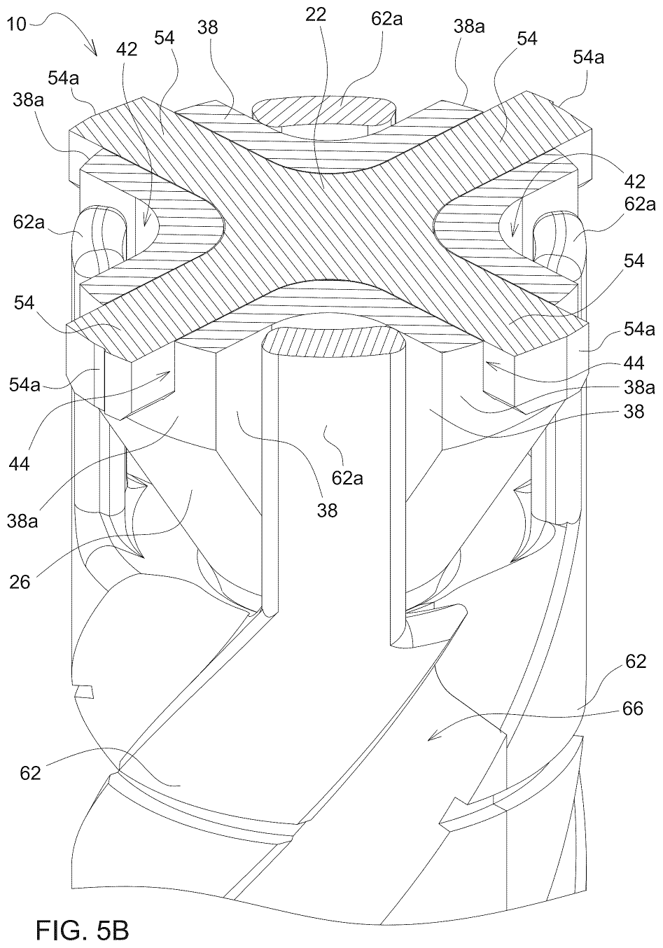

With reference to FIGS. 4-5B, the cutting head 26 is configured to receive the cutting insert 22 and engage a workpiece for performing a cutting operation. In the illustrated embodiment, the cutting head 26 includes a plurality of lands 38 arranged in a cross-shape. For example, the illustrated cutting head 26 includes four lands 38. In other embodiments, the cutting head 26 may include fewer or more lands 38, and/or the lands 38 may be arranged in other shapes, such as an X-shape or a Y-shape. The lands 38 extend from the shaft 34 along the central longitudinal axis A1. As the lands 38 extend along the central longitudinal axis A1, the lands 38 slope outwardly to a maximum outer diameter, or a maximum outer dimension, of the cutting head 26 (i.e., a first maximum outer diameter D1). The first maximum outer diameter D1 is measured perpendicular to the central longitudinal axis A1. In the illustrated embodiment, the diameter of the cutting head 26 continuously increases from the shaft 34 to the first maximum outer diameter D1. In other embodiments, the diameter of the cutting head 26 may abruptly increase (e.g., via one or more steps) or the diameter of the cutting head 26 may increase in a non-continuous manner. Once the lands 38 reach the first maximum outer diameter D1, the lands 38 extend parallel to the central longitudinal axis A1 to reach an end surface 26a of the cutting head 26 that is opposite from the shaft 34. The end surface 26a is defined by a planar surface having a cross-shape. At the end surface 26a of the cutting head 26, the first maximum outer diameter D1 is defined between an outer edge 38a of one land 38 and an outer edge 38a of another land 38 directly across from the one land 38. A plurality of flutes 42 is defined by the plurality of lands 38. Each flute 42 is defined by two adjacent lands 38.

A receptacle or pocket 44 is defined in the cutting head 26 for receiving the cutting insert 22. In the illustrated embodiment, the pocket 44 is generally cross-shaped. In other embodiments, the pocket 44 may have other shapes, depending on or independent from the shape of the lands 38. In the illustrated embodiment, each of the lands 38 defines at least a portion of the pocket 44. Specifically, the pocket 44 is defined along the portion of each of the lands 38 that extends parallel to the central longitudinal axis A1. The pocket 44 is not defined along sloping portions of the cutting head 26 in the illustrated embodiment (e.g., portions of the cutting head 26 that transition from the shaft 34 to the first maximum outer diameter D1). In other embodiments, the pocket 44 may also extend at least partly into the sloping portions.

The shank 30 is configured to be inserted in and engaged by any number of different tools, adapters, or components to receive torque from the tool, adapter, or component to rotate the bit. For example, the drilling insert 10 may be utilized with a power tool, such as a driver or hammer drill including a socket. The shank 30 is the portion of the body 18 that is inserted into and supported in the power tool. In the illustrated embodiment, the shank 30 is configured as an SDS-style shank, such as an SDS shank, and SDS Plus shank, or an SDS Max shank, and includes slots 30a and detent recesses 30b for receive coupling features from a power tool. For example, a quick-release structure, such as a ball-detent mechanism, may be employed to axially secure the bit 10 to the driver. In other embodiments, the shank 30 may be formed as a hex shank that is configured to engage a hex-shaped socket in a power tool. In still other embodiments, the shank 30 may have other configurations suitable for other styles of chucks or adapters.

The shank 30 has a shank length L2 and a second maximum outer diameter D2. The shank length L2 is measured parallel to the central longitudinal axis A1. The second maximum outer diameter D2 is measured perpendicular to the central longitudinal axis A1. In the illustrated embodiment, the shank length L2 is no more a quarter (i.e., 25%) of the total length L1 of the drilling insert 10. In some embodiments, the shank length L2 may be no more than a fifth (i.e., 20%) of the total length L1 of the drilling insert 10. In the illustrated embodiment, the second maximum outer diameter D2 is smaller than the first maximum outer diameter D1. For example, the first maximum outer diameter D1 of the cutting head 26 is at least two times greater than the second maximum outer diameter D2 of the shank 30. In some embodiments, the first maximum outer diameter D1 may be between two times greater and five times greater than the second maximum outer diameter D2. In the illustrated embodiment, the first maximum outer diameter D1 may be about three times greater than the second maximum outer diameter D2.

The shaft 34 extends from the shank 30 to the cutting head 26. As such, the shaft 34 may be understood to be a portion of the body 18 that extends between the portion of the body 18 that is inserted into and supported in the power tool, and where the body 18 begins to increase in diameter for the cutting head 26. The shaft 34 has a shaft length L3 and a third maximum outer diameter D3. The shaft length L3 is measured parallel to the central longitudinal axis A1. The third maximum outer diameter D3 is measured perpendicular to the central longitudinal axis A1. In the illustrated embodiment, the shaft length L3 may be more than half (i.e., 50%) of the total length L1 of the drilling insert 10. As such, the shaft 34 extends, or spans, a majority of the total length L1 of the body 18 of the drilling insert 10. In some embodiments, the shaft length L3 may be more than two-thirds (i.e., 66%) of the total length L1 of the drilling insert 10. In further embodiments, the shaft length L3 may be more than three-quarters (i.e., 75%) of the total length L1 of the drilling insert 10. In some embodiments, the shaft length L3 may be between 50% and 90% of the total length L1 of the drilling insert 10.

In the illustrated embodiment, the body 18 also includes a collar 46. The collar 46 is positioned between the shank 30 and the shaft 34. As such, the collar 46 may define the transition from the shank 30 to the shaft 34. The collar 46 may facilitate coupling, or mounting, of the sleeve 14 onto the shaft 34. The collar 46 has a diameter that is smaller than the first maximum outer diameter D1 of the cutting head 26 and greater than the second maximum outer diameter D2 of the shank 30 and the third maximum outer diameter D3 of the shaft 34. The illustrated collar 46 is a flange that gradually and smoothly transitions from the shank 30 and abruptly transitions (e.g., via a perpendicular shoulder) to the shaft 34. In some embodiments, the collar 46 may be a removable or detachable collar. In such embodiments, the shaft 34 may include one or more indents or other features that selectively engage corresponding features on the collar 46 to releasably secure the collar 46 on the shaft 34. In other embodiments, the body 18 may include other retention features to facilitate coupling the sleeve 14 onto the shaft 34. In still other embodiments, the collar 46 may be omitted. In such embodiments, the body 18 may not include a structure that separates and differentiates the shank 30 from the shaft 34.

The third maximum outer diameter D3 of the shaft 34 may be taken at a location along the shaft 34 that is spaced from the collar 46. The third maximum outer diameter D3 is smaller than the first maximum outer diameter D1. For example, a ratio of the third maximum outer diameter D3 to the first maximum outer diameter D1 may be less than or equal to 0.7. In some embodiments, the ratio of the third maximum outer diameter D3 to the first maximum outer diameter D1 may be less than or equal to 0.5. In the illustrated embodiment, a ratio of the third maximum outer diameter D3 to the second maximum outer diameter D2 is between 0.5 and 2. The third maximum outer diameter D3 and the second maximum outer diameter D2 are approximately equal in the illustrated embodiment such that the ratio is 1. Accordingly, the first maximum outer diameter D1 may be at least two times greater than the third maximum outer diameter D3. Alternatively, the first maximum outer diameter D1 may be between two times greater and five times greater than the third maximum outer diameter D3. As illustrated, the first maximum outer diameter D1 may be about three times greater than the third maximum outer diameter D3. In other embodiments, the second maximum outer diameter D2 and the third maximum outer diameter D3 may be different. However, it may be desirable to reduce the number of diameter transitions/changes along the length L1 of the drilling insert 10 to help transmit energy (e.g., impacts or other forces) through the drilling insert 10, as described below.

The shank 30 and the shaft 34 each have a cross-sectional area that is taken perpendicular to the central longitudinal axis A1. Specifically, the shank 30 includes at least a first cross-sectional area and a second cross-sectional area, and the shaft 34 includes a third cross-sectional area. In the illustrated embodiment, the cross-sectional areas are circular. In other embodiments, the cross-sectional areas may have other shapes, such as hexagonal. The first cross-sectional area is taken perpendicular to the axis A1 at a location of the shank 30 including the slots 30a and the detent recesses 30b. As such, the first cross-sectional area may be a smallest, or minimum, cross-sectional area for the shank 30. The second cross-sectional area is taken perpendicular to the axis A1 at location of the shank 30 not including the slots 30a and the detent recesses 30b. As such, the second cross-sectional area may be a largest, or maximum, cross-sectional area for the shank 30. The third cross-sectional area may be taken perpendicular to the axis A1 at any location along the shaft 34 away from the collar 46. In the illustrated embodiment, the third cross-sectional area is greater than 0.5 times the first cross-sectional area. Additionally, the third cross-sectional area is less than three times the second cross-sectional area. In other words, the cross-sectional area of the shaft 34 is greater than half the minimum cross-sectional area of the shank 30, but less than three times the maximum cross-sectional area of the shank 30. In other embodiments, the third cross-sectional area may be greater than 0.5 times the first cross-sectional area and may be less than two times the second cross-sectional area. Accordingly, a ratio of the cross-sectional area of the shaft 34 to the cross-sectional area of the shank 30 may be between 0.5 and 2. In some embodiments, the ratio may be 1.

With reference to FIGS. 5A and 5B, the illustrated cutting insert 22 includes a tip 50 and a plurality of legs 54. In the illustrated embodiment, the cutting insert 22 includes four legs 54. The legs 54 are arranged generally perpendicular to each other such that the cutting insert 22 is generally cross-shaped. In other embodiments, the cutting insert 22 may include fewer or more legs 54, and/or the legs 54 may be arranged in other shapes, such as an X-shape or a Y-shape. The cutting insert 22 slopes upward (i.e., in a direction at least partially along the central longitudinal axis A1) to the tip 50. The cross-shape of the cutting insert 22 is compatible to be received and fixed to the cutting head 26. In the illustrated embodiment, the cutting insert 22 is formed of carbide. In other embodiments, the cutting insert 22 may be formed of a different material. The cutting insert 22 is also formed as a unitary body. The cutting insert 22 may be fixed to the cutting head 26 within the pocket 44 via welding, brazing, or another similar means. The cutting insert 22 has a maximum outer dimension, or a fourth maximum outer diameter D4. The fourth maximum outer diameter D4 is measured perpendicular to the central longitudinal axis A1. The fourth maximum outer diameter D4 is defined between an outer edge 54a of one of the legs 54 and an outer edge 54a of a leg 54 directly across from the one of the legs 54. The fourth maximum outer diameter D4 may span over at least 50% of the first maximum outer diameter D1 of the cutting head 26. In other embodiments, the fourth maximum outer diameter D4 may span over at least 75% of the first maximum outer diameter D1. In some embodiments, the fourth maximum outer diameter D4 may be approximately equal to the first maximum outer diameter D1. In the illustrated embodiment, the fourth maximum outer diameter D4 is greater than the first maximum outer diameter D1 such that the fourth maximum outer diameter D4 spans over an entirety of the first maximum outer diameter D1. As such, a portion of at least one of the legs 54 may overhang from a corresponding one of the lands 38 of the cutting head 26.

In embodiments where the fourth maximum outer diameter D4 is greater than the first maximum outer diameter D1, the fourth maximum outer diameter D4 may be considered an overall diameter of the drilling insert 10. In embodiments where the fourth maximum outer diameter D4 is less than the first maximum outer diameter D1, the first maximum outer diameter D1 may be considered the overall diameter of the drilling insert 10. In some embodiments, the overall diameter of the drilling insert 10 may be at least 0.75 inches. In other embodiments, the overall diameter of the drilling insert 10 may be between 0.75 inches and 2 inches. In further embodiments, the overall diameter of the drilling insert 10 may be greater than 2 inches. In some embodiments, the overall diameter of the drilling insert 10 may be at least two times the third maximum outer diameter D3 of the shaft 34. For example, the overall diameter of the drilling insert 10 may be between two and five times the third maximum outer diameter D3 of the shaft 34. In some examples, the drilling insert 10 may have an overall diameter of at least 0.75 inches, and the shank 34 may have an SDS Plus configuration. In other examples, the drilling insert 10 may have an overall diameter of at least 1.25 inches, and the shank 34 may have an SDS Max configuration. In still other examples, the drilling insert 10 may have other overall diameters and/or the shank 34 may have other SDS-style configurations.

With the cutting insert 22 coupled to the cutting head 26, the cutting insert 22 and the cutting head 26 have a combined length L4. The combined length L4 is measured parallel to the central longitudinal axis A1. The combined length L4 is defined from the portion of the cutting head 26 that is adjacent, or touching, the shaft 34 to the tip 50 of the cutting insert 22. In some embodiments, the combined length L4 of the cutting insert 22 and the cutting head 26 may be less than a quarter (i.e., 25%) of the total length L1 of the drilling insert 10. In other embodiments, the combined length L4 of the cutting insert 22 and the cutting head 26 may be less than a fifth (i.e., 20%) of the total length L1 of the drilling insert 10. In the illustrated embodiment, the combined length L4 of the cutting insert 22 and the cutting head 26 is less than 10% of the total length L1 of the drilling insert 10.

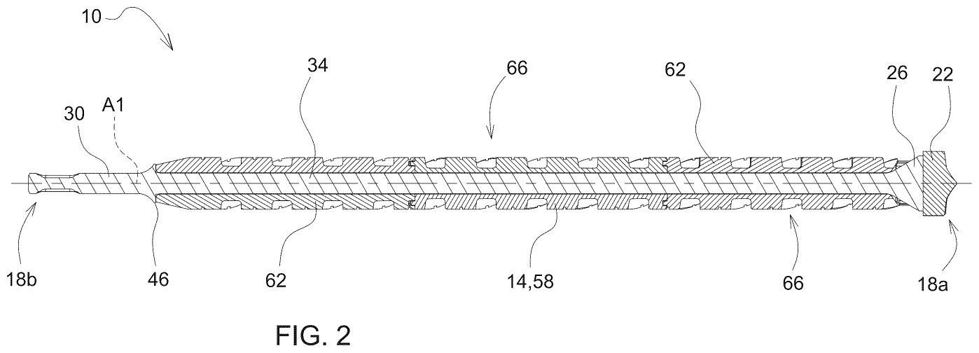

As illustrated in FIGS. 1 and 2, the sleeve 14 includes a sleeve body 58 and plurality of sleeve lands 62 wrapped helically around the sleeve body 58. The sleeve 14 may be formed of a different material than the drilling insert 10. In the illustrated embodiment, the sleeve 14 is formed of a plastic material. In other embodiments, the sleeve 14 may be formed of a rubber or another type of elastic material. In still other embodiments, the sleeve 14 may be formed of metal, such as aluminum or steel. The sleeve body 58 is configured to be mounted onto the body 18 of the drilling insert 10 such that the sleeve 14 radially surrounds the body 18 of the drilling insert 10. When mounted to the drilling insert 10, the sleeve 14 extends from the collar 46 to the cutting head 26. As such, the sleeve 14 generally spans over the shaft length L2. The plurality of sleeve lands 62 defines a plurality of sleeve flutes 66. The sleeve flutes 66 help transfer material away from the cutting head 26 during a cutting operation. At a forward end of the sleeve 14 that is adjacent to the cutting head 26, a forward portion 62a of each of the sleeve lands 62 extends parallel to the central longitudinal axis A1 of the drilling insert 10. Specifically, each of the lands 62 extends through a corresponding one of the flutes 42 defined by the lands 38 of the cutting head 26. The lands 62 help align the sleeve 14 on the body 18 and inhibit the sleeve 14 from rotating relative to the body 18. The sleeve 14, however, may shift or slide axially a small amount along the body 18 between the collar 46 and the cutting head 26.

By providing the sleeve 14 separately from the drilling insert 10, the drilling insert 10 is able to transfer energy between the first end 18a and the second end 18b of the body 18 more efficiently. For example, when the drilling insert 10 is connected to a hammer drill, the hammer drill may impact the second end 18b of the body 18. The impacts travel or propagate through the body 18 to the first end 18a and, thereby, to a workpiece. Since the sleeve 14 is not fixed to the drilling insert, the impacts do not need to also travel through the mass of the sleeve 14. As such, as energy is transferred between the first end 18a and the second end 18b of the body 18, the energy does not travel through the plurality of sleeve lands 62 and the plurality of sleeve flutes 66. In addition, since the impacts travel along the drilling insert 10 as waves, and the body 18 is designed to minimize the number of changes in cross-sectional areas, the impacts do not become attenuated or distorted as they travel down the body. Therefore, the energy travels a more direct route, and thus a more efficient route, between the first end 18a and the second end 18b. Additionally, the plurality of sleeve lands 62 and the plurality of sleeve flutes 66 have an increased lifespan over typical drilling inserts. Specifically, the removal of energy transfer from the power tool through the plurality of sleeve lands 62 and the plurality of sleeve flutes 66 reduces the stress and risk of fracture for the plurality of sleeve lands 62 and the plurality of sleeve flutes 66.

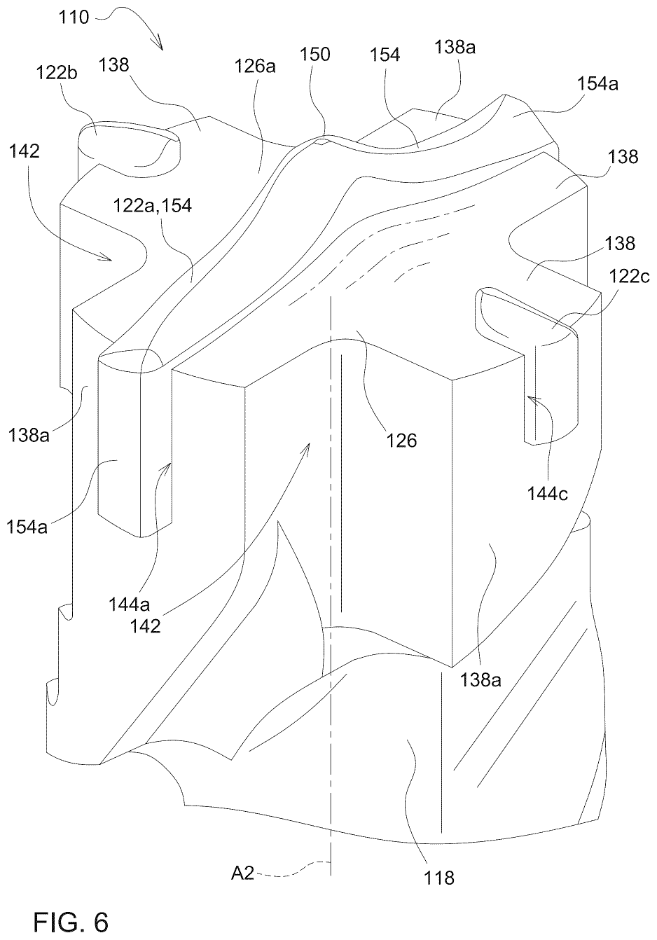

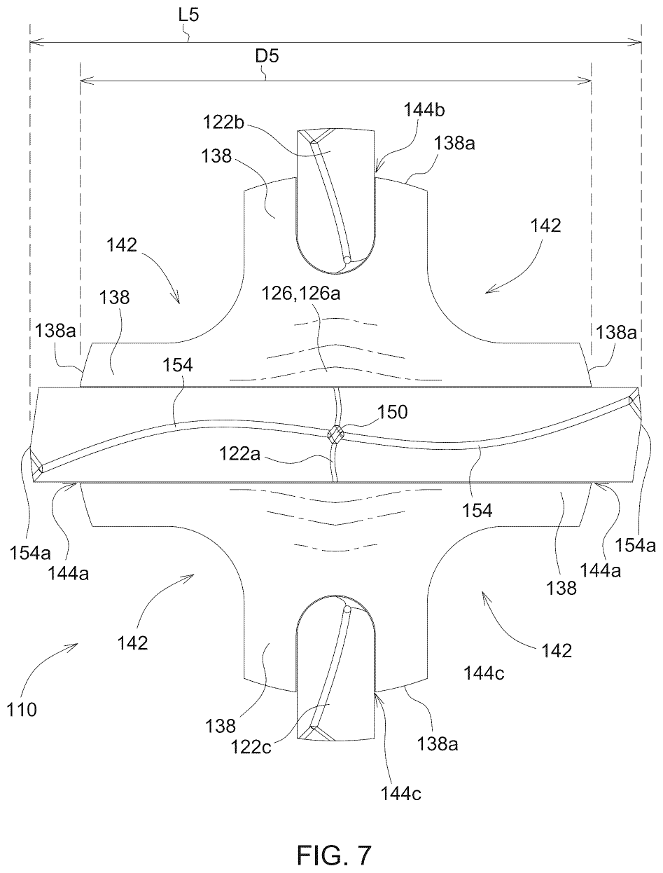

FIGS. 6 and 7 illustrate a portion of a drilling insert 110 according to another embodiment. The illustrated drilling insert 110 includes a body 118, a first cutting insert 122a, a second cutting insert 122b, and a third cutting insert 122c. The body 118 may be substantially similar to the body 18 of FIG. 4. Reference is made to the description of the drilling insert 10 described above for description of features, elements, and alternatives of the drilling insert 110 not explicitly included below.

As illustrated in FIGS. 6 and 7, the body 118 includes a cutting head 126 that is configured to receive the cutting inserts 122a, 122b, 122c and engage a workpiece for performing a cutting operation. In the illustrated embodiment, the cutting head 126 includes a plurality of lands 138 arranged in a cross-shape. For example, the illustrated cutting head 126 includes four lands 138. In other embodiments, the cutting head 126 may include fewer or more lands 138, and/or the lands 138 may be arranged in other shapes, such as an X-shape or a Y-shape. Each of the lands 138 extends parallel to a central longitudinal axis A2 of the drilling insert 110. At an end surface 126a of the cutting head 126, a first maximum outer diameter D5 (i.e., a maximum outer diameter of the cutting head 126) is defined between outer edges 138a of lands 138 positioned across from each other. However, the outer diameter of the cutting head 126 may be constant at all locations where the lands 138 are present. A plurality of flutes 142 is defined by the plurality of lands 138. Each flute 142 is defined by two adjacent lands 138.

A first pocket 144a, a second pocket 144b, and a third pocket 144b are defined in the cutting head 126 for receiving a corresponding one of the first cutting insert 122a, the second cutting insert 122b, and the third cutting insert 122c. In the illustrated embodiment, the first pocket 144a is formed in the shape of a straight line that extends across two lands 138 positioned across from one another. Specifically, the first pocket 144a is defined between the outer edges 138a of two lands 138 positioned across from one another such that the first pocket 144a spans an entirety of the first maximum outer diameter D5. The second pocket 144b and the third pocket 144c are defined in the cutting head 126 on opposite sides of the first pocket 144a. Specifically, each of the second pocket 144b and the third pocket 144c is defined at the outer edge 138a of a corresponding one of the lands 138 that do not define the first pocket 144a. The second pocket 144b and the third pocket 144c are not connected to each other or to the first pocket.

The illustrated first cutting insert 122a is a linear plate including a tip 150 and two legs 154 extending from the tip 150 in opposite directions from one another. As such, the legs 154 are arranged in a straight line extending across the cutting head 126. The first cutting insert 122a may be fixed to the cutting head 126 within the first pocket 144a via welding, brazing, or another similar means. In the illustrated embodiment, the first cutting insert 122a is formed of carbide. In other embodiments, the first cutting insert 122a may be formed of a different material. The first cutting insert 122a may span at least half (i.e., 50%) of the first maximum outer diameter D5 of the cutting head 126. In the illustrated embodiment, the insert 122a spans at least an entirety of the first maximum outer diameter D5. That is, the first cutting insert 122a extends at least between the outer edge 138a of one land 138 and the outer edge 138a of a land 138 directly across from the one land 138. In the illustrated embodiment, the first cutting insert 122a has a maximum outer dimension, or a length L5, that is greater than the first maximum outer diameter D5 of the cutting head 126. The length L5 is defined between an outer edge 154a of one of the legs 154 and an outer edge 154a of the other of the legs 154. As such, at least a portion of the first cutting insert 122a overhangs from a corresponding land 138 at each end of the first cutting insert 122a. In some embodiments, the length L5 may be approximately equal to the first maximum outer diameter D5.

Each of the second cutting insert 122b and the third cutting insert 122c includes a body that is significantly smaller in length than the first cutting insert 122a. Specifically, the second cutting insert 122b and the third cutting insert 122c are received in a corresponding one of the second pocket 144b and the third pocket 144c. As such, the second cutting insert 122b and the third cutting insert 122c are positioned on opposite sides of the first cutting insert 122a from one another and do not extend across the first pocket 144a and the first cutting insert 122a. Each of the second cutting insert 122b and the third cutting insert 122c may be fixed to the cutting head 126 within a corresponding one of the second pocket 144b and the third pocket 144c via welding, brazing, or another similar means. In the illustrated embodiment, each of the second cutting insert 122b and the third cutting insert 122c is formed of carbide. In other embodiments, the second cutting insert 122b and the third cutting insert 122c may be formed of different materials. At least a portion of each of the second cutting insert 122b and the third cutting insert 122c may overhang from the outer edge 138a of a corresponding land 138 of the cutting head 126. In some embodiments, outer edges of the second and third cutting inserts 122b, 122c may be flush with the outer edge 138a of the corresponding lands 138.

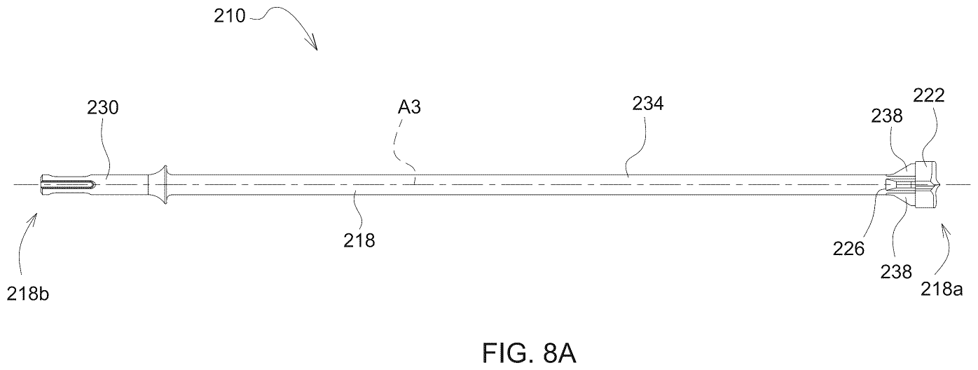

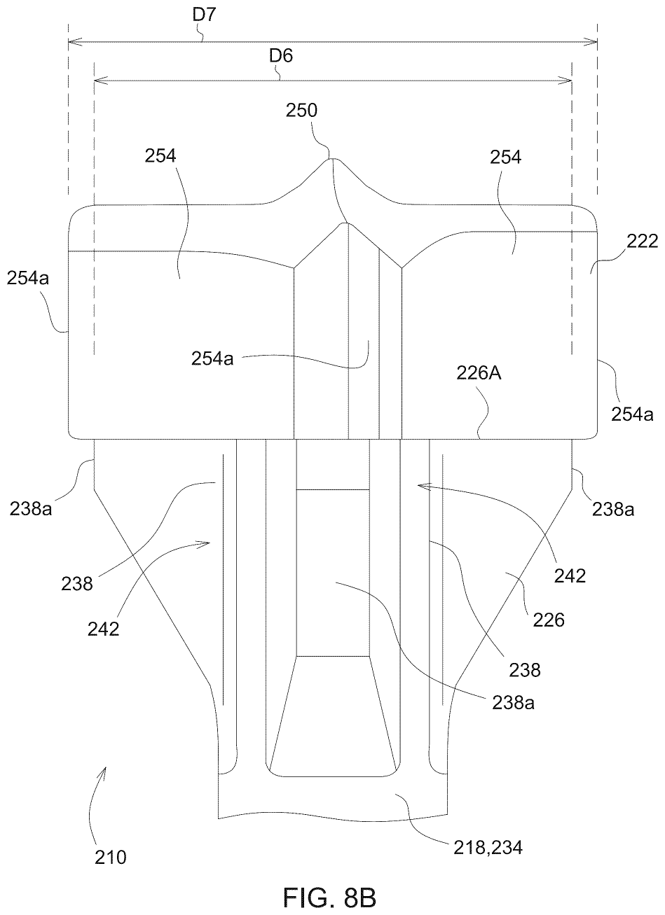

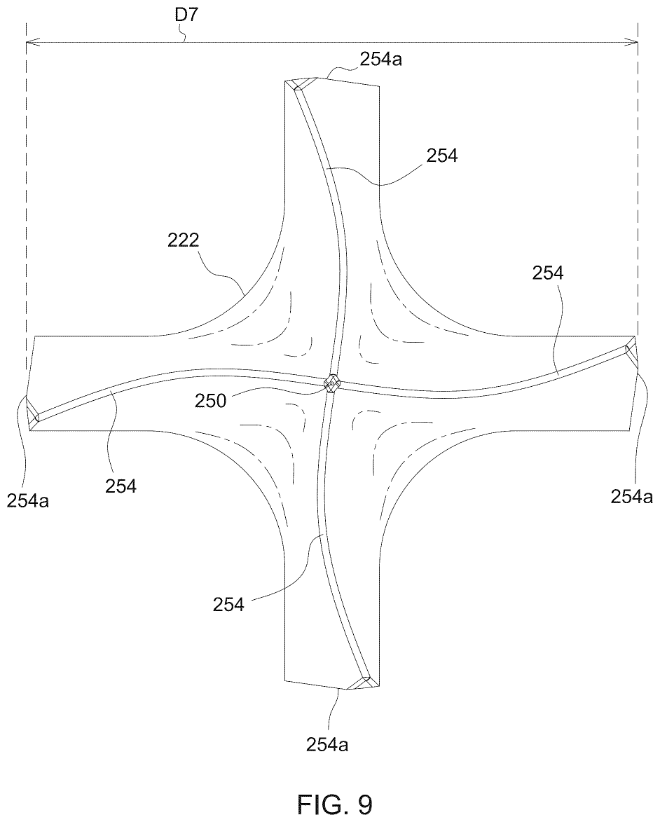

FIGS. 8A-9 illustrate a drilling insert 210 according to another embodiment. The illustrated drilling insert 210 includes a body 218 and a cutting insert 222. The body 218 and the cutting insert 222 may be substantially similar to the body 18 and the cutting insert 22 of FIG. 4. Reference is made to the description of the drilling insert 10 described above for description of features, elements, and alternatives of the drilling insert 210 not explicitly included below.

As illustrated in FIG. 8A, the body 218 includes a cutting head 226 positioned at a first end 218a of the body 218, a shank 230 positioned at a second end 218b of the body 218, and a shaft 234 extending between the cutting head 226 and the shank 230. A sleeve may be mounted to the body 218, as similarly described with respect to the sleeve 14 of FIG. 1. The cutting head 226 is configured to support the cutting insert 222 and engage a workpiece for performing a cutting operation.

As shown in FIGS. 8B and 9, in the illustrated embodiment, the cutting head 226 includes a plurality of lands 238 arranged in a cross-shape. For example, the illustrated cutting head 226 includes four lands 238. In other embodiments, the cutting head 226 may include fewer or more lands 238, and/or the lands 238 may be arranged in other shapes, such as an X-shape or a Y-shape. The lands 238 extend from the shaft 234 along a central longitudinal axis A3. As the lands 238 extend along the central longitudinal axis A3, the lands 238 slope outwardly to a maximum outer diameter of the cutting head 226 (i.e., a first maximum outer diameter D6). The first maximum outer diameter D6 is measured perpendicular to the central longitudinal axis A3. In the illustrated embodiment, the diameter of the cutting head 226 continuously increases from the shaft 234 to the first maximum outer diameter D6. In other embodiments, the diameter of the cutting head 226 may abruptly increase (e.g., via one or more steps) or the diameter of the cutting head 226 may increase in a non-continuous manner. Once the lands 38 reach the first maximum outer diameter D6, the lands 238 extend parallel to the central longitudinal axis A3 to reach an end surface 226a of the cutting head 226. At the end surface 226a, the first maximum diameter D6 is defined between an outer edges 238a of one land 238 and an outer edge 238a of another land 238 directly across from the one land 238. A plurality of flutes 242 is defined by the plurality of lands 238. Each flute 242 is defined by two adjacent lands 238.

The cutting insert 222 includes a tip 250 and a plurality of legs 254. In the illustrated embodiment, the cutting insert 222 includes four legs 254. The legs 254 are arranged generally perpendicular to each other such that the cutting insert 222 is generally cross-shaped. In other embodiments, the cutting insert 222 may include fewer or more legs 254, and/or the legs 254 may be arranged in other shapes, such as an X-shape or a Y-shape. The cross-shape of the cutting insert 222 is compatible to be received on and fixed to the cutting head 226. In the illustrated embodiment, the cutting insert 222 is attached directly to the end surface 226a of the cutting head 226 such that the end surface 226a of the cutting head 226 abuts a flat, bottom surface of the cutting insert 222. Specifically, the flat bottom surface of the cutting insert 222 may be fixed to the flat end surface 226a of the cutting head 226 via welding, brazing, or another similar means, and the cutting insert 222 may be aligned such that each of the legs 254 of the cutting insert 222 directly attaches to a corresponding one of the shaft lands 235. In the illustrated embodiment, the cutting insert 222 is formed of carbide. In other embodiments, the cutting insert 222 may be formed of another material. The cutting insert 222 is also formed as a unitary body. The cutting insert 222 has a maximum outer dimension, or a second maximum outer diameter D7. The second maximum other diameter D7 is measured perpendicular to the central longitudinal axis A3. The second maximum outer diameter D7 is defined between an outer edge 254a of one of the legs 254 and an outer edge 254a of a leg 254 directly across from the one of the legs 254. The second maximum diameter D7 may span over at least 50% of the first maximum diameter D6 of the cutting head 226. In other embodiments, the second maximum outer diameter D7 may span over at least 75% of the first maximum outer diameter D6. In some embodiments, the second maximum outer diameter D2 may be approximately equal to the first maximum outer diameter D6. In the illustrated embodiment, the second maximum outer diameter D7 is greater than the first maximum outer diameter D6 such that the second maximum outer diameter D7 spans over an entirety of the first maximum diameter D6. As such, a portion of at least one of the legs 254 may overhang from a corresponding one of the shaft lands 235 of the shaft 234. In some embodiments, each of the outer edges 254a of the legs 254 may be flush with the outer edge 238a of the corresponding lands 238.

In each of the embodiments described herein, each of the drilling inserts 10, 110, 210 includes, or comprises, no more than four cutting inserts 22, 122a, 122b, 122c, 222 attached to the cutting head 26, 126, 226. More specifically, each of the drilling inserts 10, 110, 210 includes, or comprises, no more than three cutting inserts 22, 122a, 122b, 122c, 222. The small number of cutting inserts may advantageously improve the ease of manufacturing and repair for the drilling inserts 10, 110, 210. For example, the drilling insert 10 of FIG. 1 only includes one cutting insert 22 and therefore may only include one welding/brazing step to attach the cutting insert 22 to the cutting head 26. For conventional drilling inserts, the time taken to attach many small cutting inserts may greatly increase the difficulty and time expended in manufacturing.

As described above, some or all illustrated features may be omitted in a particular implementation within the scope of the present disclosure, and some illustrated features may not be required for implementation of all embodiments. The features described above may be implemented in an order different from the order described above and does not prohibit implementation in another order or combination. While not explained in detail for each embodiment and/or construction, the features of the disclosure described herein may be included on a drilling insert independent of other features and are not limited to the illustrated disclosure. Embodiments and limitations disclosed herein are not dedicated to the public under the doctrine of dedication if the embodiments and/or limitations: (1) are not expressly claimed in the claims; and (2) are or are potentially equivalents of express elements and/or limitations in the claims under the doctrine of equivalents.

Various features and advantages of the invention are set forth in the following claims.

1. A drilling insert comprising:
a body having a first end, a second end opposite the first end, and a length measured between the first end and the second end, the body including
a cutting head positioned at the first end of the body, the cutting head having a first maximum outer diameter,
a shank positioned at the second end of the body and configured to be coupled to a tool, the shank having a second maximum outer diameter that is less than the first maximum outer diameter, and
a shaft extending between the shank and the cutting head, the shaft having a third maximum outer diameter that is less than the first maximum outer diameter, the shaft extending a majority of the length of the body; and
a cutting insert coupled to the cutting head and spanning over at least 50% of the first maximum outer diameter of the cutting head.

2. The drilling insert of claim 1, wherein the cutting head defines a pocket that receives the cutting insert.

3. The drilling insert of claim 1, wherein the cutting insert is generally cross-shaped.

4. The drilling insert of claim 1, wherein the cutting insert is a linear plate.

5. The drilling insert of claim 4, wherein the cutting insert is a first cutting insert, and the drilling insert further comprising a second cutting insert and a third cutting insert coupled to the cutting head on opposite sides of the first cutting insert.

6. The drilling insert of claim 1, wherein a ratio of the third maximum outer diameter of the shaft to the second maximum outer diameter of the shank is between 0.5 and 2.

7. The drilling insert of claim 6, wherein the third maximum outer diameter of the shaft is approximately equal to the second maximum outer diameter of the shank such that the ratio is approximately 1.

8. The drilling insert of claim 1, wherein a ratio of the third maximum outer diameter of the shaft to the first maximum outer diameter of the cutting head is less than or equal to 0.7.

9. The drilling insert of claim 8, wherein the ratio of the third maximum outer diameter of the shaft to the first maximum outer diameter of the cutting head is less than or equal to 0.5.

10. The drilling insert of claim 1, wherein the body also includes a collar positioned between the shank and the shaft.

11. The drilling insert of claim 1, wherein the shaft extends at least 75% of the length of the body.

12. The drilling insert of claim 1, wherein the cutting head has a first cross-sectional area, the shank has a second cross-sectional area, the shaft has a third cross-sectional area, and wherein a ratio of the third cross-sectional area to the second cross-sectional area is between 0.5 and 3.

13. The drilling insert of claim 12, wherein the shank includes a plurality of slots and a plurality of detent recesses that are configured to receive coupling features of a tool, wherein the ratio of the third cross-sectional area to the second cross-sectional area is greater than 0.5 when the second cross-sectional area is taken at a location of the shank including the plurality of slots and the plurality of detent recesses, and wherein the ratio of the third cross-sectional area to the second cross-sectional area is less than 3 when the second cross-sectional area is taken at a location of the shank spaced from the plurality of slots and the plurality of detent recesses.

14. The drilling insert of claim 1, wherein the cutting head continuously increases in diameter from the third maximum outer diameter to the first maximum outer diameter.

15. The drilling insert of claim 1, wherein the cutting insert defines an outer dimension that is greater than the first maximum outer diameter of the cutting head.

16. The drilling insert of claim 1, wherein a bottom surface of the cutting insert is welded to an end surface of the body at the first end.

17. The drilling insert of claim 1, wherein the drilling insert has an overall diameter that is at least two times the second maximum outer diameter.

18. The drilling insert of claim 1, wherein the drilling insert has an overall diameter of at least 0.75 inches, and wherein the shank has an SDS plus configuration.

19. The drilling insert of claim 1, wherein the drilling insert has an overall diameter of at least 1.25 inches, and wherein the shank has an SDS Max configuration.

20. A drilling insert comprising:
a body having a first end, a second end opposite the first end, and a length measured between the first end and the second end, the body including
a cutting head positioned at the first end of the body, the cutting head having a first cross-sectional area,
a shank positioned at the second end of the body and configured to be coupled to a tool, the shank having a second cross-sectional area that is less than the first cross-sectional area, and
a shaft extending between the shank and the cutting head, the shaft having a third cross-sectional area that is less than the first cross-sectional area, the shaft extending a majority of the length of the body; and
a cutting insert coupled to the cutting head,
wherein an end surface of the cutting head opposite the shaft is defined by a planar surface.

21. The drilling insert of claim 20, wherein the end surface of the cutting head defines a pocket that receives the cutting insert.

22. The drilling insert of claim 20, wherein the end surface of the cutting head abuts a bottom surface of the cutting insert.

23. A drilling insert comprising:
a body having a first end, a second end opposite the first end, and a length measured between the first end and the second end, the body including
a cutting head positioned at the first end of the body, the cutting head having a first maximum outer dimension,
a shank positioned at the second end of the body and configured to be coupled to a tool, the shank having a second maximum outer dimension that is less than the first maximum outer dimension, and
a shaft extending between the shank and the cutting head, the shaft having a third maximum outer dimension that is less than the first maximum outer dimension, the shaft extending a majority of the length of the body; and
one or more cutting inserts coupled to the cutting head, the one or more cutting inserts including no more than four cutting inserts.

24. The drilling insert of claim 23, wherein one of the one or more cutting inserts has a fourth outer dimension that is greater than the first maximum outer dimension.

25. The drilling insert of claim 23, wherein one of the one or more cutting inserts has a fourth outer dimension that is at least 50% of the first maximum outer dimension.

26. The drilling insert of claim 23, wherein the one or more cutting inserts includes no more than three cutting inserts.

27. The drilling insert of claim 20, wherein the planar surface has a cross-shape.
